(19) United States
(12) Patent Application Publication
(10) Pub. No.: US 2025/0166593 A1
(43) Pub. Date: May 22, 2025

(54) TONE GENERATION AND SYNCHRONIZATION

(71) Applicant: IPC Systems, Inc., Jersey City, NJ (US)

(72) Inventors: Daniel R. Elliott, Southbury, CT (US); Elias Koutikas, Oxford, CT (US)

(21) Appl. No.: 18/792,185

(22) Filed: Aug. 1, 2024

Related U.S. Application Data
(60) Provisional application No. 63/601,502, filed on Nov. 21, 2023.

(51) Int. Cl. G10H 1/02

(52) U.S. Cl. CPC G10H 1/02

(57) ABSTRACT

Methods, systems, and computer program products are provided for enhancing and synchronizing tone generation. A tone generation element includes an ID attribute, an iterate attribute, a barge attribute, a cleardb attribute, and an override attribute to enhance tone generation. A tone child element of the tone generation element specifies a tone, and a silence child element of the tone generation element specifies a silence interval. The silence child element includes a periods per minute attribute for synchronizing tones. Invoking the tone generation element enables tone generation.

### RELATED APPLICATION

This application claims priority to and the benefit of U.S. Provisional Application No. 63/601,502, filed on Nov. 21, 2023, which is hereby incorporated by reference in its entirety.

### BACKGROUND

### Field

The present invention generally relates to tone generation enhancements and synchronization, and more particularly to implementing, enhancing, and synchronizing Media Server Markup Language (MSML) tone generation.

### Related Art

MSML tone generation is described by the Request for Comment (RFC) 5707. MSML can be used to control and invoke different types of services on Internet Protocol (IP) servers such as IP media servers, referred to simply as media servers. Clients can use MSML to define how multimedia sessions interact on a media server and to apply services to individuals or groups of users. MSML can be used, for example, to control media server conferencing features such as video layout and audio mixing, create sidebar conferences or personal mixes, and set properties of media streams. Additionally, clients can use MSML to define media processing dialogs to be used as parts of application interactions with users or conferences. Transformation of media streams to and from users or conferences as well as interactive voice response (IVR) dialogs are examples of such interactions.

### SUMMARY

The foregoing implementation and enhancement of tone generation, including tone generation synchronization, is accomplished by systems, methods, and non-transitory computer medium storing instructions for invoking a tone generation element and/or additional elements to cause one or more devices to generate tones, stop generating tones, and/or the like.

In one embodiment, a system is provided for enhanced tone generation including at least one or more processors and a computer-readable storage medium coupled to the one or more processors and comprising instructions thereon that, when executed by the one or more processors, cause the one or more processors to invoke a tone generation element to cause a client device to generate a tone. The tone generation element comprises an ID attribute, an iterate attribute, a barge attribute, a cleardb attribute, and an override attribute. In an example implementation, the iterate attribute is an integer variable specifying a total number of iterations, the barge attribute is a first Boolean variable that defines whether or not tones may be interrupted by Dual Tone Multi-Frequency (DTMF), the cleardb attribute is a second Boolean variable that defines whether or not a digit buffer is cleared, and the override attribute is a third Boolean variable that defines whether or not the tone can be stopped in response to a command.

In some embodiments, the tone generation element comprises a tone child element, wherein the tone child element specifies the tone. In an example implementation, the tone child element comprises any one of (i) a tone1 child element including a first frequency and a first attenuation, (ii) a tone2 child element including a second frequency and a second attenuation, or (iii) a combination of (i) and (ii). In an additional example implementation, the tone child element comprises a silence child element.

In further embodiments, the tone generation element comprises a silence child element, wherein the silence child element specifies a silence interval. In an example implementation, the silence child element comprises a periods per minute attribute for synchronizing tones.

In another embodiment, there is a method provided for enhanced tone generation. The method comprises invoking a tone generation element to generate a tone, the tone generation element comprising an ID attribute, an iterate attribute, a barge attribute, a cleardb attribute, and an override attribute. In an example implementation, the iterate attribute is an integer variable specifying a total number of iterations, the barge attribute is a first Boolean variable that defines whether or not tones may be interrupted by DTMF, the cleardb attribute is a second Boolean variable that defines whether or not a digit buffer is cleared, and the override attribute is a third Boolean variable that defines whether or not the tone can be stopped in response to a command.

In an example implementation, the method further comprises setting the iterate attribute to set the total number of iterations. In another example implementation, the method further comprises setting the barge attribute to enable interruption by DTMF. The method may further comprise receiving an incoming DTMF digit and stopping the tone in response to receiving the incoming DTMF digit. In yet another example implementation, the method further comprises setting the override attribute to enable stopping the tone in response to the command. The method may further comprise invoking the command to stop the tone. In an example implementation, the command is a stop tone sequence.

In some embodiments, the tone generation element comprises a tone child element, wherein the tone child element specifies the tone. In an example implementation, the tone child element comprises any one of (i) a tone1 child element including a first frequency and a first attenuation, (ii) a tone2 child element including a second frequency and a second attenuation, or (iii) a combination of (i) and (ii). In an embodiment, the method further comprises setting any one of (i) the first frequency, (ii) the first attenuation, (iii) the second frequency, (iv) the second attenuation, or (v) any combination of (i)-(iv) to set a frequency and an attenuation of the tone. In an additional example implementation, the tone child element comprises a silence child element. In some embodiments, the method further comprises setting the silence duration attribute to set a tone off period.

In further embodiments, the tone generation element comprises a silence child element, wherein the silence child element specifies a silence interval. In an example implementation, the silence child element comprises a periods per minute attribute for synchronizing tones. In some embodiments, the method further comprises setting the periods per minute attribute to set one or more silence durations per minute and generating synchronized tones at the end of a silence duration of the one or more silence durations per minute. In an example implementation, the periods per minute attribute is set to four, setting the one or more silence durations per minute to fifteen seconds and generating the synchronized tones at the end of the silence duration of the one or more silence durations per minute at any one of (i) zero seconds, (ii) fifteen seconds, (iii) thirty seconds, or (iv) forty-five seconds of a minute.

In another embodiment, there is non-transitory computer-readable medium having stored thereon one or more sequences of instructions, which when executed by one or more processors, cause the one or more processors to perform invoking a tone generation element to generate a tone, the tone generation element. The tone generation element includes an ID attribute, an iterate attribute, a barge attribute, a cleardb attribute, and an override attribute. In an example implementation, the iterate attribute is an integer variable specifying a total number of iterations, the barge attribute is a first Boolean variable that defines whether or not tones may be interrupted by DTMF, the cleardb attribute is a second Boolean variable that defines whether or not a digit buffer is cleared, and the override attribute is a third Boolean variable that defines whether or not the tone can be stopped in response to a command.

In an example implementation, the non-transitory computer-readable medium having stored thereon one or more sequences of instructions, which when executed by one or more processors, cause the one or more processors to further perform setting the iterate attribute to set the total number of iterations. In another example implementation, the non-transitory computer-readable medium having stored thereon one or more sequences of instructions, which when executed by one or more processors, cause the one or more processors to further perform setting the barge attribute to enable interruption by DTMF. The non-transitory computer-readable medium may have stored thereon one or more sequences of instructions, which when executed by one or more processors, cause the one or more processors to further perform receiving an incoming DTMF digit and stopping the tone in response to receiving the incoming DTMF digit. In yet another example implementation, the non-transitory computer-readable medium having stored thereon one or more sequences of instructions, which when executed by one or more processors, cause the one or more processors to further perform setting the override attribute to enable stopping the tone in response to the command. The non-transitory computer-readable medium may have stored thereon one or more sequences of instructions, which when executed by one or more processors, cause the one or more processors to further perform invoking the command to stop the tone. In an example implementation, the command is a stop tone sequence.

In some embodiments, the tone generation element comprises a tone child element, wherein the tone child element specifies the tone. In an example implementation, the tone child element comprises any one of (i) a tone1 child element including a first frequency and a first attenuation, (ii) a tone2 child element including a second frequency and a second attenuation, or (iii) a combination of (i) and (ii). In an embodiment, the non-transitory computer-readable medium may have stored thereon one or more sequences of instructions, which when executed by one or more processors, cause the one or more processors to further perform setting any one of (i) the first frequency, (ii) the first attenuation, (iii) the second frequency, (iv) the second attenuation, or (v) any combination of (i)-(iv) to set a frequency and an attenuation of the tone. In an additional example implementation, the tone child element comprises a silence child element. In some embodiments, the non-transitory computer-readable medium may have stored thereon one or more sequences of instructions, which when executed by one or more processors, cause the one or more processors to further perform setting the silence duration attribute to set a tone off period.

In further embodiments, the tone generation element comprises a silence child element, wherein the silence child element specifies a silence interval. In an example implementation, the silence child element comprises a periods per minute attribute for synchronizing tones. In some embodiments, the non-transitory computer-readable medium may have stored thereon one or more sequences of instructions, which when executed by one or more processors, cause the one or more processors to further perform setting the periods per minute attribute to set one or more silence durations per minute and generating synchronized tones at the end of a silence duration of the one or more silence durations per minute. In an example implementation, the periods per minute attribute is set to four, setting the one or more silence durations per minute to fifteen seconds and generating the synchronized tones at the end of the silence duration of the one or more silence durations per minute at any one of (i) zero seconds, (ii) fifteen seconds, (iii) thirty seconds, or (iv) forty-five seconds of a minute.

In an example implementation, the tone is any one of (i) a continuous tone, (ii) a basic tone, (iii) a multiple pulse tone, or (iv) a sequential tone.

### BRIEF DESCRIPTION OF THE DRAWINGS

The features and advantages of the example embodiments presented herein will become more apparent from the detailed description set forth below when taken in conjunction with the following drawings.

FIG. 1 is a block diagram illustrating an example sequence of generated tones, in accordance with an embodiment.

FIG. 2 is a block diagram illustrating an example continuous tone, in accordance with an embodiment.

FIG. 3 is a block diagram illustrating an example basic tone, in accordance with an embodiment.

FIG. 4 is a block diagram illustrating an example multiple pulsed tone, in accordance with an embodiment.

FIG. 5 is a block diagram illustrating an example sequential tone, in accordance with an embodiment.

FIG. 6 is a block diagram illustrating an operating environment for a system to implement synchronized tone generation, in accordance with an embodiment.

FIG. 7 is a block diagram illustrating an operating environment for a media server to control and invoke services for client devices.

FIG. 8 is a flow chart of a method for synchronizing tone generation.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware only implementation, a software only implementation, or an implementation combining software and hardware aspects. The following detailed description is therefore not to be taken in a limiting sense, and the scope of the present disclosure is defined by the appended claims and their equivalents.

Generally, example aspects of the embodiments described herein provide systems, methods, and non-transitory computer medium storing instructions for implementing, enhancing, and/or synchronizing tone generation.

In some embodiments, there is provided a so called MSML dialog base package that includes a foundational set of tools, libraries, or components that provide the necessary infrastructure or framework to create and manage interactive dialogs or conversations. In some implementations, an MSML dialog base package includes a tone generation element (i.e., “<tonegen>” in MSML) for customized tone generation. The tone generation element is a specific component within the MSML used to generate customizable tones and manage tone sequences within interactive communication systems. A sequence of varying tones with optional silence intervals can be composed using the tone generation element. Tone generation elements include an identifier (ID) attribute and an optional ID that may be referenced for sending events to a tonegen primitive. A “tonegen primitive” refers to a foundational tool or component within a broader dialog base package or system that encompasses not only the “tonegen element” but also other necessary infrastructure, libraries, or functionalities to create and manage interactive dialogs or conversations. This primitive includes the “tone generation element” as an element or feature but may also consist of additional tools and components for handling dialogues, user interactions, and various media-related functionalities.

Tone generation elements also include an iterate attribute, a numeric value specifying the total number of iterations. A tone element (i.e., “<tone>”) and a silence element (i.e., “<silence>”) are child elements of the tone generation element. The tone element and the silence element can be used to specify a single tone or sequence of tones. The tone element specifies a single tone with an optional silence interval. The tone specification consists of two tone frequencies, their attenuation values, a duration of the tone, and the number of times to repeat the tone. In some embodiments, setting the duration value to zero will make the tone have an indefinite duration. The tone1 element (i.e., “<tone1>”) and the tone2 (i.e., “<tone2>”) element are child elements of the tone element. The tone1 element and tone2 element can specify a tone and an optional silence interval to be inserted at the end of tone generation. A tone is defined by tone1 and tone2 elements, including the frequency and attenuation of the tone for example. Each tone element must contain at least one of the tone1 element or the tone2 element or may contain the tone1 element and the tone2 element exactly once. A tone element with both a tone1 element and a tone2 element specified will have an output of the frequency defined by the tone1 element plus the frequency defined by the tone2 element. The silence element is an optional element in the tone generation element or tone element that can be used to insert a silence interval. The tone generation exit element (i.e., “<tonegenexit>”) is invoked when the tone generation operation is complete or is terminated as a result of receiving a terminate event.

Tone generation as described herein may enable proper operation to generate a sequence of tones, for example in a virtual Media Resource Function (vMRF). In some embodiments, there is no period between the ending of one tone and the beginning of the next tone in a sequence when a silence period is not specified via a silence element. In other embodiments, there may be a predefined period between tones in a sequence whose associated tone elements do not specify a silence period. A sequence of tones may be repeated in some examples (e.g., using the iterate attribute). The frequency of the tones can range from 0 Hertz (Hz) to 3,999 Hz in example implementations.

To enhance tone generation and enable proper or otherwise desired operation, a barge attribute, a cleardb attribute, and an override attribute are included in a tone generation element. Thus, an enhanced tone generation element can include an ID attribute, an iterate attribute, a barge attribute, a cleardb attribute, an override attribute, and/or the like. An enhanced tone generation element and/or tone element can also include a periods per minute attribute for tone synchronization.

In some embodiments, the ID attribute is a String variable that represents a series of characters used to identify a tone. The ID attribute can be referenced for sending events to the tonegen primitive. The iterate attribute is an integer variable specifying the total number of iterations. The iterate attribute can have a value indicating infinite repetitions in some example implementations. The barge attribute is a Boolean variable that defines whether tones may be interrupted or otherwise stopped by Dual Tone Multi-Frequency (DTMF) detection (e.g., in response to an incoming DTMF digit). The DTMF digit barging the tone can be stored in the digit buffer. The cleardb attribute is a Boolean variable that defines whether the digit buffer is cleared, for example prior to starting the tone. The override attribute is a Boolean variable that can stop the tone on command. For example, the override attribute can be used to stop a tone with an infinite duration (e.g., a tone element with a duration value set to zero).

In certain embodiments, the periods per minute attribute is included in a silence element. Therefore, the periods per minute attribute can be included in a silence element of a tone generation element and/or in a silence element of a tone element. However, the periods per minute attribute can be restricted to only silence elements of a tone generation element in some example implementations, for example to prevent multiple tone elements from attempting to synchronize with conflicting information. The periods per minute attribute is an integer variable that sets a number of periods per minute devices can generate synchronized tones. Determining the integer value to set the number of periods and the subsequent synchronization of tones is described in more detail herein.

Example pseudocode is presented below detailing the tone generation element:

```
<tonegen id=String iterate=integer barge=Boolean cleardb=Boolean
override=Boolean>
    <!-- Tone generator allows customized tone generation.
      A sequence of varying tones with optional silence intervals can be
      composed using the <tonegen> element. Child elements of <tonegen>,
      namely <tone> and <silence>, specify a single tone or sequence of tones --
      >
    <tone duration=integer iterate= integer >
      <!-- The <tone> element specifies a single tone with an optional silence
      interval.
      The tone specification consists of two tone frequencies, their attenuation
      values, a duration of the tone, and the number of times to repeat the tone. -
      ->
      <tone1 freq= atten=integer/>
      <tone2 freq= atten=integer/>
      <silence duration=integer />
    </tone>
    [ <tone ... < /tone>]
    ...
    [ <tone ... < /tone>]
    <silence duration=integer periodsPerMinute=integer />
</tonegen>
<tonegenexit
  <!-- The <tonegenexit> element must be invoked when the tone generation operation
  completes or is terminated as a result of receiving the terminate event. The
  <tonegenexit> element may be used to send events when the tone generation has
  completed. -->
</tonegenexit>
```

A stop tone sequence can be used to stop any tones that are being played. Setting the override attribute to true enables the stop tone sequency to stop tones. The following pseudocode details the stop tone sequence:
<tonegen id=someTone stop/>

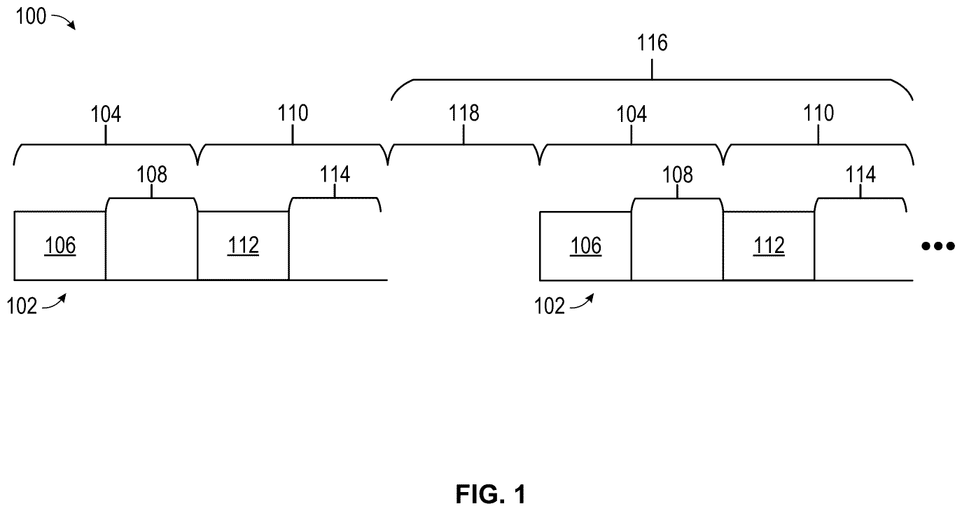

FIG. 1 is a block diagram illustrating an example sequence of generated tones 100. In some embodiments, the sequence of generated tones 100 includes a tone sequence 102 with a first tone 104 including first tone on period 106 and a first tone off period 108, and a second tone 110 with a second tone on period 112, and a second tone off period 114. The sequence of generated tones 100 also includes repeat iterations 116 with a silence period 118 and the generation period of a repeated tone sequence 102.

The repeat iterations 116 can be implemented (e.g., defining the number of iterations) using the iterate attribute of the tone generation element. For example, the iterate attribute can have a value of three, indicated the tone sequence 102 will be played and followed by two repeat iterations 116. In some examples, the iterate attribute is used to cause the repeat iterations 116 to occur indefinitely, thereby causing the tone sequence 102 and/or the silence period 118 to occur indefinitely.

The silence period 118 can be implemented (e.g., defining the duration of the silence period 118) using a silence element. In example implementations, the silence element is a child element of the tone generation element. The silence element enables setting the duration of the silence period 118 in multiples of ten milliseconds. For example, a silence element with a value of one will define a silence duration of ten milliseconds, a silence element with a value of two will define a silence duration of twenty milliseconds, a silence element with a value of three will define a silence duration of thirty milliseconds, and the like.

In some embodiments, the tone element is used to define the tone attributes (e.g., duration, frequency, attenuation, etc.) and iteration attributes of the first tone 104 and the second tone 110. The child elements of the tone element, the tone1 element and/or the tone2 element, define a frequency and/or attenuation of a tone. If both tone1 and tone2 are present, then the defined frequencies are summed together to determine the frequency of the tone, and the silence period 118 occurs after the tone. The silence element can also be used as a child element of the tone element to define the durations of the first tone off period 108 and the second tone off period 114. The following pseudocode defines the duration of the tone sequences 102, the duration of the first tone 104 (i.e., the duration of the first tone on period 106 and the duration of first tone off period 108) the second tone 110 (i.e., the duration of the second tone on period 112 and the duration of the second tone off period 114), and the silence period 118. The pseudocode also defines the number of repeat iterations 116:

```
<tonegen id=someTone iterate=forever >
  < tone duration=250ms iterate=2 >
    <tone1 freq=250 atten-0 />
    <tone2 freq=450 atten=0 />
    <silence duration=250ms>
  </tone >
  <silence duration=500ms>
</tonegen >
```

As shown in the above pseudocode, the duration of the first tone on period 106 and the second tone on period 112 is two-hundred and fifty milliseconds (i.e., as indicated by “<tone duration=250 ms . . . ”). The first tone 104 and the second tone 110 both occur as indicated by the “<tone . . . iterate=2>” portion. If the iterate value was set to one, only the first tone 104 would occur in the tone sequence 102. The frequency of the first tone 104 during the first tone on period 106 and the second tone 110 during the second tone on period 112 is defined by adding the frequencies defined in the tone1 element and the tone2 element. The duration of the first tone off period 108 and the second tone off period 114 is defined by the child silence element of the tone element (i.e., “<silence duration=250 ms>”). The number of repeat iterations 116 is set to an indefinite amount in this example (i.e., “<tonegen . . . iterate=forever>”). Thus, the tone sequence 102 and silence period 118 may repeat until a command to cease is initiated. The duration of the silence period 118 is indicated by the child silence element of the tone generation element (i.e., “<silence duration=500 ms>”).

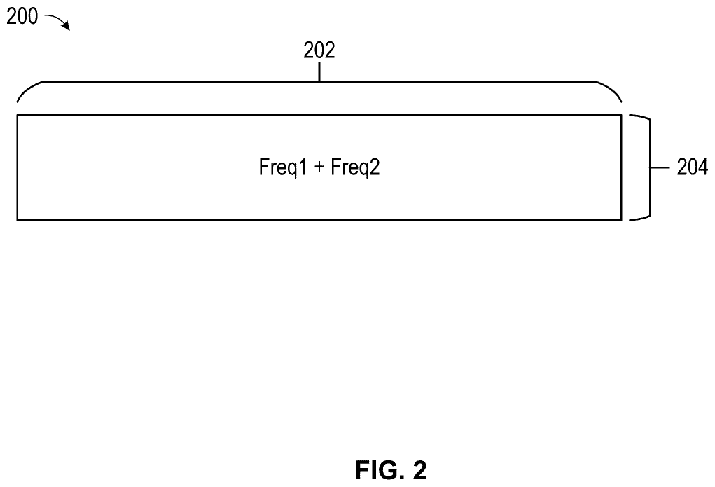

FIG. 2 is a block diagram illustrating an example continuous tone 200. A dial tone is an example continuous tone 200. The continuous tone 200 has a duration 202 and an attenuation 204. For example, the following pseudocode sets the duration 202, the frequency, and the attenuation 204 and enables the continuous tone 200 to be stopped:

```
<tonegen id=ContinousTone barge=true override=true>
  <tone duration=0ms>
    <tone1 freq=350 atten=0/>
    <tone2 freq=440 atten=0/>
  </tone>
</tonegen >
```

To specify the continuous tone 200, the duration value of the tone element of the contentious tone has a value of zero to make the duration 202 indefinite. In other examples, the continuous tone 200 may have a specified duration (e.g., sixty seconds). The continuous tone 200 has no silence period in this example implementation. The frequency of the continuous tone 200 and the attenuation 204 are set by the values of the tone1 element and the tone2 element. The barge attribute of the continuous tone 200 is set to true to enable the continuous tone 200 to be stopped by an incoming DTMF digit. The override attribute of the continuous tone 200 is set to true to enable the continuous tone 200 to be stopped by a command. The continuous tone 200 can therefore be stopped using a command enabled by the override attribute.

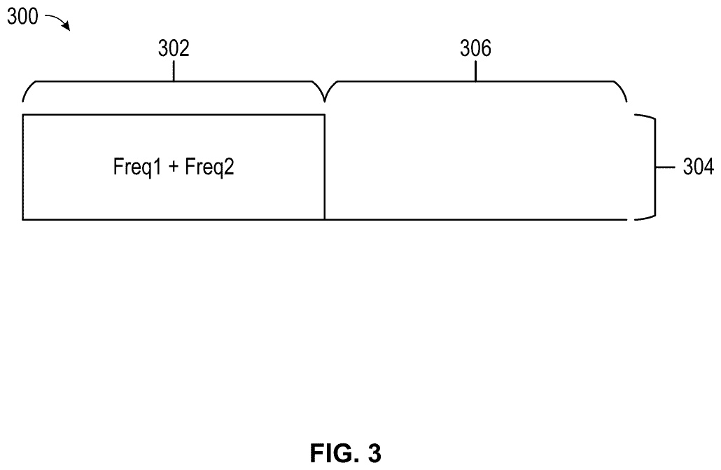

FIG. 3 is a block diagram illustrating an example basic tone 300. The basic tone 300 includes an on duration 302 where a sound is generated and an attenuation 304. The basic tone 300 also includes an off duration 306 where a sound is not generated. An intrusion tone, busy tone, record warning tone, error tone, and ring back tone are examples of a basic tone 300. The following example pseudocode sets the on duration 302, the off duration 306, the frequency of the sound generated during the on duration 302, the iterations to infinite, and the attenuation 304. The following pseudocode also enables the basic tone 300 to be stopped:

```
<tonegen id=BasicTone iterate=forever override=true >
  <tone duration=250ms:
    <tone1 freq=480 atten=0/>
    <tone2 freq=620 atten-0/>
    <silence duration=250ms />
  </tone>
</tonegen >
```

The duration value of the tone element is two-hundred and fifty milliseconds, so the on duration 302 is two-hundred and fifty milliseconds. The duration value of a silence child element of the tone element is two-hundred and fifty milliseconds, so the off duration 306 is two-hundred and fifty milliseconds. The tone1 and tone2 elements set the frequency and attenuation 304 of the sound generated during the on duration 302. The tone generation element of the basic tone 300 sets the number of iterations (i.e., via the iterate attribute). The basic tone 300 can be set to a number of iterations or infinite iterations.

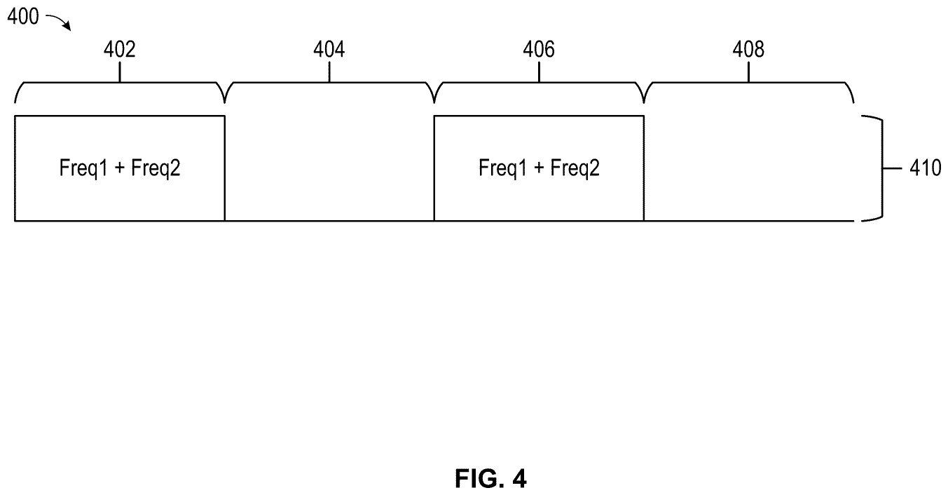

FIG. 4 is a block diagram illustrating an example multiple pulsed tone 400. A multiple pulsed tone 400 enables a repeated sound (e.g., beep) with a delay between the sounds. multiple pulsed tone 400 can be repeated by setting the iterate attribute of a tone generation element of the multiple pulsed tone 400. The multiple pulsed tone 400 includes a first pulsed on duration 402 for generating a sound with a frequency and an attenuation 410, a first pulsed off duration 404, a second pulsed on duration 406 for generating a sound with a frequency and the attenuation 410, and a second pulsed off duration 408. The following pseudocode sets the duration and frequency of the first pulsed on duration 402, the duration of the first pulsed off duration 404, the duration and frequency of the second pulsed on duration 406, the second pulsed off duration 408, the iterations to of the multiple pulsed tone 400 to infinite, and the attenuation 410 and enables the multiple pulsed tone 400 to be stopped:

```
<tonegen id=MultiplePluses iterate=forever override=true >
  <tone duration=200ms iterate=2>
    <tone1 freq=400 atten=0/>
    <tone2 freq=450 atten=0/>
    <silence duration=400ms />
  </tone>
  <silence duration=1600ms />
</tonegen
```

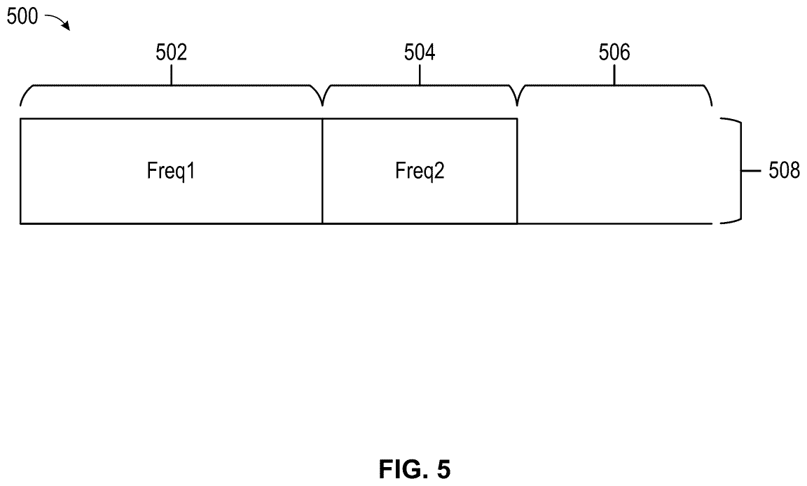

FIG. 5 is a block diagram illustrating an example sequential tone 500. The sequential tone 500 enables a combination of tones to be generated and repeated. Splash on and Splash off tones are examples of the sequential tone 500. The sequential tone 500 includes a first sequential tone on duration 502 for generating a sound with a first frequency, a second sequential tone on duration 504 for generating a sound with a second frequency with a second frequency, and a sequential tone off duration 506. The first sequential tone on duration 502 and the second sequential tone on duration 504 have an attenuation 508. The following pseudocode sets the duration and first frequency of the first sequential tone on duration 502, the duration and second frequency of the second sequential tone on duration 504, the attenuation 508, and the sequential tone off duration 506. The pseudocode additionally sets the sequential tone 500 to iterate once and enables the sequential tone 500 to be stopped:

```
<tonegen id=SequentialTones iterate=1 override=true >
  <tone duration=300ms>
    <tone1 freq=1209 atten-0/>
  </tone>
  <tone duration=150ms
    <tone1 freq=1477 atten=0/>
  </tone>
</tonegen >
```

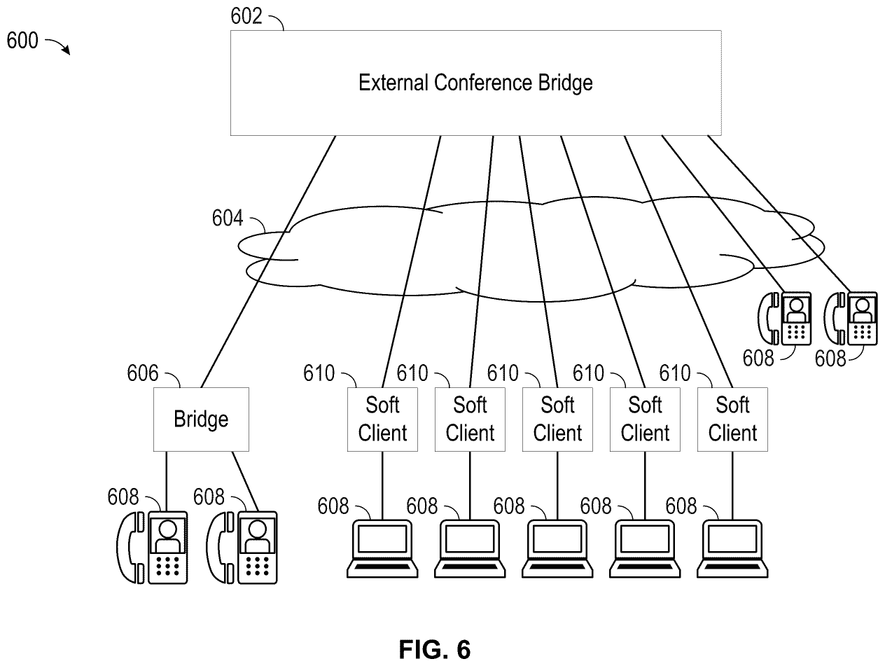

FIG. 6 is a block diagram illustrating an operating environment 600 for a system to implement synchronized tone generation. The operating environment 600 includes an external conference bridge 602 that can enable devices to connect to virtual meetings, such as conference telephone calls, video conferencing, and the like. The external conference bridge 602 can connect to devices via a network 604. For example, the external conference bridge 602 connects to a local bridge 606 and soft clients 610 to enable client devices 608 to connect to virtual meetings. The client devices 608 that connect via a local bridge 606 may be telephones or other conference telephone call capable devices. The client device 608 that connect via a soft client 610 may be wireless network capable (e.g., Voice over Internet Protocol capable) devices. In example implementations, the external conference bridge 602 can directly connect to client devices 608 via the network 604.

In some embodiments, tones need to be synchronized to prevent an excessive number of tones and/or unnecessary tones from being played. For example, the record warning tone played in response to a user recording a call can be unnecessarily played in some examples. A record warning tone may be played periodically (e.g., every 15 seconds) when a client device 608 is recording a call. When multiple client devices 608 with recording enabled join a call, then record warning tones may be continuously played and may make the call unusable. Thus, the record warning tones can be synchronized so users hear only a single tone instead of multiple tones at random intervals.

In some embodiments, to synchronize the record warning tone, the tones are synchronized to start playing at the start of each minute. Each minute can be evenly divided into identical periods using the periods per minute attribute. In an example implementation, four periods are used, resulting in 15 second periods. A period is measured in integral number of milliseconds. So, a valid periods per minute attribute must satisfy the number of periods per minute multiplied by the length of each period to equal sixty-thousand milliseconds. Therefore, a periods per minute attribute can validly set the number of periods per minute to a single period (e.g., synchronizing tones at the beginning of each minute), two periods (e.g., synchronizing tons at the beginning of each minute and the thirty second mark, three periods, four periods, five periods, six periods, eight periods, ten periods, twelve periods, fifteen periods, sixteen periods, twenty periods, twenty-four periods, twenty-five periods, thirty periods, thirty-two periods, forty periods, forty-eight periods, fifty periods, or sixty periods. In some examples, the client devices 608 and/or other devices may evaluate whether the period per minute attribute has a valid integer assigned. For example, if the periods per minute value will not cause the periods per minute multiplied by the length of each period to equal sixty-thousand milliseconds, the client devices 608 may adjust the value to a closest acceptable value (e.g., switching the value of the periods per minute attribute from thirteen to twelve).

In certain embodiments, the periods per minute attribute, used for synchronizing tones such as the record warning tones, is a special silence period. The silence duration can be defined by the number of periods per minute, enabling synchronization to the start of every minute. The tone start can be played immediately and then each successive tone played should be synchronized to the next expected time. Application servers, media servers, and client devices 608 can reference or otherwise utilize a networking protocol or reference time source to have synchronized clocks, enabling the devices to determine when tone generation should be performed to synchronize tone generation between client devices 608. In an example implementation, the client devices 608 utilize the Network Time Protocol for clock synchronization. The periods per minute attribute (i.e., periodsPerMinute) is used in the following example to illustrate a possible syntax for this feature.

In some embodiments, the record warning tone needs to be played every fifteen seconds. All users in a conference need to synchronize the record warning tone so that one beep is heard by all conference participants. The record warning tone will be sent on the minute and then every fifteen seconds. Therefore, the record warning can be sent at the zero, fifteen, thirty, and/or forty-five second mark each minute. For example, the first record warning will be played immediately when a user joins the conference. The second warning tone will be delayed fifteen seconds until the next synchronized interval, defined by the periods per minute attribute, occurs. The tone after the second tone is played then all tones will be played at the zero, fifteen, thirty, and/or forty-five second mark each minute.

The following pseudocode example is for playing a synchronized record warning tone to multiple participants:

```
<tonegen id=ToneSync override=true>
  <tone duration=500 iterate=forever>
    <tone1 freq=1400 atten=0/>
    <silence periodsPerMinute=4/>
  </tone>
</tonegen >
```

The periods per minute attribute is set to four with the tone set to iterate indefinitely in the example pseudocode. Therefore, client devices 608 will generate the tone every fifteen seconds, such as at the starting mark, fifteen second mark, thirty second mark, and the forty-five second mark of each minute defined for tone synchronization. The override attribute is set to true, so the client devices 608 may stop generating the tone in response to a command.

Tone synchronization can be implemented for multiple tones played at the same time, multiple tones to be played at different times, and/or the like. Additionally, client devices 608 can be instructed to generate synchronized tones in response to a trigger (e.g., a client joining a meeting, a client initiating recording, etc.), to generate synchronized tones indefinitely, to generate synchronized tones for a period, and/or the like.

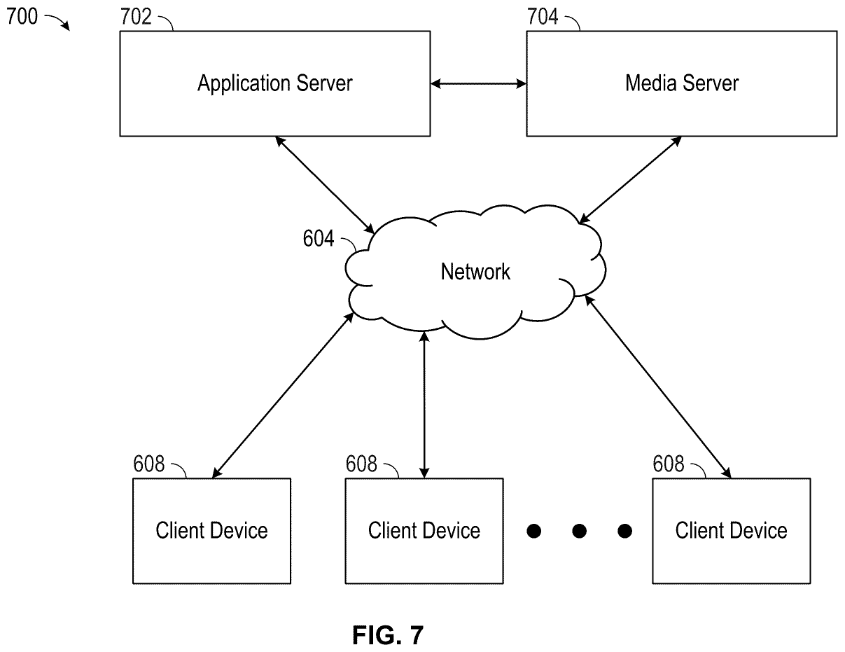

FIG. 7 is a block diagram of an operating environment 700 for a media server to control and invoke services for client devices. The operating environment 700 includes an application server 702, a media server 704, the network 604, and client devices 608. There may be any number of client devices 608, and different amounts of the client devices 608 may synchronize different tones. The application server 702 and the media server 704 can communicate with the client devices 608 via the network 604. In this embodiment, the application server 702 is separate from the media server 704, but other configurations can also be used (e.g., the application server 702 can be located at the same node as the media server 704, the application server 702 and the media server 704 can be the same server, etc.).

In some embodiments, the application server 702 and the media server 704 provide a platform for executing telephony service applications (e.g., a trading platform). The application server 702 handles the logic and processing of various telephony applications. These applications can include services like interactive voice response systems, call routing, voicemail, conferencing, and the like. The application server 702 manages the execution of these applications and interacts with other components of the telephony system to deliver the desired functionality. The application server 702 can use signaling protocols to establish, modify, and terminate communication sessions, establish sessions with client devices 608, negotiate what types of media will be used during a session, provide information regarding tones to devices (e.g., types, durations, frequencies), and/or the like.

The media server 704 handles the media aspects of telephony services, including audio, video, and other multimedia content. In the context of telephony, the media server 704 handles tasks such as audio conferencing, voice playback, recording, transcoding, and the like. The media server 704 can receive messages from the application server 702 indicating invoked elements, such as an invoked tone generation element. To execute the elements as the application server 702 requests when the application server 702 invokes elements, the media server 704 can configure audio processing components of the client devices 608, generate a waveform that represents one or more desired audio signals according to the invoked element, mix the desired audio signals with other audio streams (e.g., a voice stream during a conference call), transmit the audio signal(s) to client devices 608 to cause one or more of the client devices 608 to generate a tone according to the invoked element(s), and the like.

For example, the application server 702 can invoke the tone generation element and/or other elements described above. When invoking the tone generation element and/or other elements, the application server 702 sends a message to the media server 704 indicating that the tone generation element and/or other elements have been invoked. In response, the media server 704 can process the request to invoke the tone generation element and/or other elements. The media server 704 may process the request, including configuring audio processing components of the client devices 608, generating a waveform that represents one or more desired audio signals according to the invoked element(s), mix the desired audio signals with other audio streams (e.g., a voice stream during a conference call), transmit the audio signal(s) to the client devices 608, and/or the like to cause one or more of the client devices 608 to generate a tone, stop generating a tone, synchronize tones, and/or the like. The operations of the application server 702 and the media server 704 can vary based on system architecture, the capabilities of the application server 702 and the media server 704, and the communication protocols used.

To enable the client devices 608 to generate synchronized tones, the application server 702 can invoke a tone generation element that includes a silence child element with a periods per minute attribute. The media server 704 can execute the tone generation element (e.g., generating audio waveform(s) according to the invoked tone generation element) to enable the client devices 608 to generate synchronized tones according to the periods per minute attribute. The periods per minute attribute sets the number of periods per minute and therefore the times the client devices 608 can generate synchronized tones. For example, the periods per minute attribute may be set to six, so the client devices 608 can generate a synchronized tone at the zero, ten, twenty, thirty, forty, and/or fifty second mark of each minute.

The following pseudocode example is a template for enabling enhanced tone generation, such as the tone generation described above:

```
<tonegen id=String iterate=integer barge=Boolean cleardb=Boolean override=Boolean>
  <tone duration=integer iterate= integer >
    <tone1 freq=integer atten=integer/>
    <tone2 freq=integer atten=integer/>
    <silence duration=integer | periodsPerMinute=integer />
  </tone>
  [ <tone ... </tone>]
  ...
  [ <tone ... </tone>]
  <silence duration=integer | periodsPerMinute= integer />
  <tonegenexit
    <send target=“source” event=“app.String” namelist=“tonegen.amt
tonegen.end”/>
    or
    <exit namelist=“tonegen.amt tonegen.end”/>
  </tonegenexit>
</tonegen>
```

The application server 702, the media server 704, the client devices 608, and/or other devices can exchange information associated with tone generation and synchronization. For example, a tone generation end report can detail why tone generation is stopped. The tone generation end report can indicate that the tone generation completed successfully (e.g., the number of tones generated reached the iteration value), tone generation stopped in response to receiving a DTMF digit, a new tone generation replaces a previously invoked tone, the tone generation was interrupted by a command (e.g., DTMF command), the vMRF had insufficient resources to complete the request, one or more invalid elements and/or attributes in the tone generation element, the generation operation was terminated by a control agent (e.g., using a <dialogend> element or <tonegen> stop command), and the like. Additionally, a tone generation runtime report can indicate the amount of time the tone generation element was running.

The following pseudocode is an example for invoking a synchronized period tone:

```
<tonegen id=Sequential override=true iterate=12>
  <tone duration=500ms iterate=7>
    <tone1 freq=1477 atten=10/>
    <silence duration=500>
  </tone>
  <silence periodsPerMinute=10/>
  <tonegenexit <send ... /> /tonegenexit>
</tonegen >
```

As indicated by the tone element, the synchronized period tone has seven iterations of five-hundred milliseconds of tone on and five-hundred milliseconds of silence for a duration of seven seconds. The tone will be generated twelve times (e.g., as indicated by “<tonegen . . . iterate=12>”), and the tone will begin at intervals defined by the periods per minute attribute. The periods per minute attribute has a value of ten, so the tone can begin at zero, six, twelve, eighteen, twenty-four, thirty, thirty-six, forty-two, forty-eight, or fifty-four seconds of each minute. In example implementations, the tone will start at zero, twelve, twenty-four, thirty-six, forty-eight, zero, and twelve seconds for the seven iterations. In another example, the tone will start at six, eighteen, thirty, forty-two, fifty-four, six, and eighteen seconds for the seven iterations.

The next example pseudocode below includes two tones:

```
<tonegen id=Sequential override=true iterate=12>
  <tone duration=500ms iterate=6>
    <tone1 freq=1477 atten=10/>
    <tone2 freq=1206 atten=10/>
    <silence periodsPerMinute=50/>
  </tone>
  <tone duration=500ms > <tone1 freq=1209 atten=10/></tone>
  <silence periodsPerMinute=10/>
  <tonegenexit <send ... /> /tonegenexit>
</tonegen >
```

The first tone includes six iterations of two-hundred and fifty millisecond of tone on (i.e., defined by the tone1 element and the tone2 element) with a tone specific period per minutes attribute with a value of fifty. The first tone followed by the second tone will be played twelve times. The periods per minute attribute has a value of ten, so the first tone should start at zero, six, twelve, eighteen, twenty-four, thirty, thirty-six, forty-two, forty-eight, or fifty-four seconds of each minute.

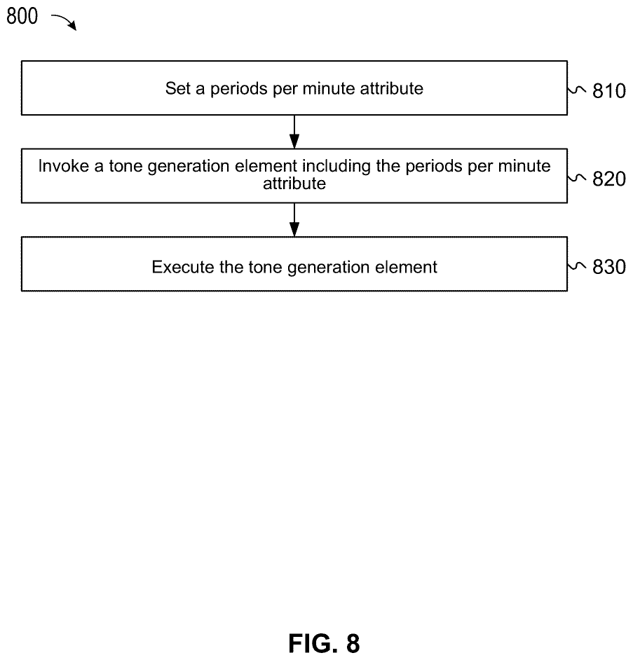

FIG. 8 is a flow chart of a method 800 for synchronizing tone generation. The method 800 begins at operation 810, and a periods per minute attribute is set. For example, the application server 702 set a periods per minute attribute so a plurality of the client devices 608 will synchronize the generation of a tone. In example implementations, the application server 702 can set the periods per minute attribute to any one of: one, enabling the plurality of client devices 608 to generate synchronized tones at the start of each minute; two, enabling the plurality of client devices 608 to generate synchronized tones at the start of each minute and thirty seconds after the start of each minute; three, enabling the plurality of client devices 608 to generate synchronized tones at the start of each minute and every twenty seconds after the start of each minute; four, enabling the plurality of client devices 608 to generate synchronized tones at the start of each minute and every fifteen seconds after the start of each minute; five, enabling the plurality of client devices 608 to generate synchronized tones at the start of each minute and every twelve seconds after the start of each minute; six, enabling the plurality of client devices 608 to generate synchronized tones at the start of each minute and every ten seconds after the start of each minute; eight, enabling the plurality of client devices 608 to generate synchronized tones at the start of each minute and every seven and one half seconds after the start of each minute; ten, enabling the plurality of client devices 608 to generate synchronized tones at the start of each minute and every six seconds after the start of each minute; twelve, enabling the plurality of client devices 608 to generate synchronized tones at the start of each minute and every five seconds after the start of each minute; fifteen, enabling the plurality of client devices 608 to generate synchronized tones at the start of each minute and every four seconds after the start of each minute; sixteen, enabling the plurality of client devices 608 to generate synchronized tones at the start of each minute and every three and three quarters seconds after the start of each minute; twenty, enabling the plurality of client devices 608 to generate synchronized tones at the start of each minute and every three seconds after the start of each minute; twenty-four, enabling the plurality of client devices 608 to generate synchronized tones at the start of each minute and every two and a half seconds after the start of each minute; twenty-five, enabling the plurality of client devices 608 to generate synchronized tones at the start of each minute and every two and four tenths seconds after the start of each minute; thirty, enabling the plurality of client devices 608 to generate synchronized tones at the start of each minute and every two seconds after the start of each minute; thirty-two, enabling the plurality of client devices 608 to generate synchronized tones at the start of each minute and every one and seven eighths seconds after the start of each minute; forty, enabling the plurality of client devices 608 to generate synchronized tones at the start of each minute and every one and a half seconds after the start of each minute; forty-eight, enabling the plurality of client devices 608 to generate synchronized tones at the start of each minute and every one and one quarter seconds after the start of each minute; fifty, enabling the plurality of client devices 608 to generate synchronized tones at the start of each minute and every one and two tenths seconds after the start of each minute; or sixty, enabling the plurality of client devices 608 to generate synchronized tones at the start of each minute and every second after the start of each minute.

In operation 820, a tone generation element is invoked. For example, the application server 702 invokes a tone generation element including the periods per minute attribute. The tone generation element can include a tone child element, and the tone child element can specify one or more characteristics of the one or more synchronized tones (e.g., frequency, attenuation, silence periods, etc.).

In example implementations, the tone generation element comprises an ID attribute, an iterate attribute, a barge attribute, a cleardb attribute, and/or an override attribute. The iterate attribute is an integer variable specifying a total number of iterations. The barge attribute is a first Boolean variable that defines whether tones may be interrupted by DTMF. The cleardb attribute is a second Boolean variable that defines whether a digit buffer is cleared. The override attribute is a third Boolean variable that defines whether the tone can be stopped in response to a command. Thus, the method 800 can further include setting the iterate attribute of the tone generation element to a total number of iterations. The method 800 can also include setting the barge attribute to enable interruption by DTMF, receiving an incoming DTMF digit, and stopping the tone in response to receiving the incoming DTMF digit. The method 800 can also include setting the override attribute to enable stopping the tone in response to a command and invoking the command to stop the tone.

In operation 830, the tone generation element can be executed. For example, the application server 702 and/or the media server 704 executes the tone generation element. In response, the plurality of client devices 608 can generate synchronized tones. In some embodiments, the method 800 further includes generating a waveform that represents a tone defined by the tone generation element and instructing the plurality of client devices to generate the one or more synchronized tones at one or more times according to the periods per minute attribute. The client devices 608 may utilize a networking protocol (e.g., Network Time Protocol) or reference time source to synchronize clocks.

Additional aspects of the present disclosure are listed in the following clauses:

Clause 1. A system, comprising: one or more processors; and a computer-readable storage medium coupled to the one or more processors and comprising instructions thereon that, when executed by the one or more processors, cause the one or more processors to: invoke a tone generation element to cause a client device to generate a tone, the tone generation element comprising: an ID attribute, an iterate attribute, a barge attribute, a cleardb attribute, and an override attribute.

Clause 2. The system of clause 1, wherein the tone generation element comprises: a tone child element, wherein the tone child element specifies the tone.

Clause 3. The system of clause 2, wherein the tone child element comprises any one of (i) a tone1 child element including a first frequency and a first attenuation, (ii) a tone2 child element including a second frequency and a second attenuation, or (iii) a combination of (i) and (ii).

Clause 4. The system of clause 2, wherein the tone child element comprises a silence child element.

Clause 5. The system of clause 1, wherein the tone generation element comprises: a silence child element, wherein the silence child element specifies a silence interval.

Clause 6. The system of clause 5, wherein the silence child element comprises a periods per minute attribute for synchronizing tones.

Clause 7. The system of clause 1, wherein: the iterate attribute is an integer variable specifying a total number of iterations; the barge attribute is a first Boolean variable that defines whether or not tones may be interrupted by DTMF; the cleardb attribute is a second Boolean variable that defines whether or not a digit buffer is cleared; and the override attribute is a third Boolean variable that defines whether or not the tone can be stopped in response to a command.

Clause 8. A method comprising: invoking a tone generation element to generate a tone, the tone generation element comprising: an ID attribute; an iterate attribute; a barge attribute; a cleardb attribute; and an override attribute.

Clause 9. The method of clause 8, wherein the tone generation element comprises: a tone child element, wherein the tone child element specifies the tone.

Clause 10. The method of clause 9, wherein the tone child element comprises any one of (i) a tone1 child element including a first frequency and a first attenuation, (ii) a tone2 child element including a second frequency and a second attenuation, or (iii) a combination of (i) and (ii).

Clause 11. The method of clause 10, further comprising setting any one of (i) the first frequency, (ii) the first attenuation, (iii) the second frequency, (iv) the second attenuation, or (v) any combination of (i)-(iv) to set a frequency and an attenuation of the tone.

Clause 12. The method of clause 9, wherein the tone child element comprises a silence child element, the silence child element comprising a silence duration attribute.

Clause 13. The method of clause 12, further comprising: setting the silence duration attribute to set a tone off period.

Clause 14. The method of clause 8, wherein the tone generation element comprises a silence child element, wherein the silence child element specifies a silence interval.

Clause 15. The method of clause 14, wherein the silence child element comprises a periods per minutes attribute for synchronizing tones.

Clause 16. The method of clause 15, further comprising: setting the periods per minute attribute to set one or more silence durations per minute; and generating synchronized tones at an end of a silence duration of the one or more silence durations per minute.

Clause 17. The method of clause 16, wherein: the periods per minute attribute is set to four, setting the one or more silence durations per minute to fifteen seconds; and generating the synchronized tones at the end of the silence duration of the one or more silence durations per minute at any one of (i) zero seconds, (ii) fifteen seconds, (iii) thirty seconds, or (iv) forty-five seconds of a minute.

Clause 18. The method of clause 8, wherein: the iterate attribute is an integer variable specifying a total number of iterations; the barge attribute is a first Boolean variable that defines whether or not tones may be interrupted by DTMF; the cleardb attribute is a second Boolean variable that defines whether or not a digit buffer is cleared; and the override attribute is a third Boolean variable that defines whether or not the tone can be stopped in response to a command.

Clause 19. The method of clause 18, further comprising: setting the iterate attribute to set the total number of iterations.

Clause 20. The method of clause 18, further comprising: setting the barge attribute to enable interruption by DTMF.

Clause 21. The method of clause 20, further comprising: receiving an incoming DTMF digit; and stopping the tone in response to receiving the incoming DTMF digit.

Clause 22. The method of clause 18, further comprising: setting the override attribute to enable stopping the tone in response to the command.

Clause 23. The method of clause 22, further comprising: invoking the command to stop the tone.

Clause 24. The method of clause 23, wherein: the command is a stop tone sequence.

Clause 25. The method of clause 8, wherein the tone is any one of (i) a continuous tone, (ii) a basic tone, (iii) a multiple pulse tone, or (iv) a sequential tone.

Clause 26. A non-transitory computer-readable medium having stored thereon one or more sequences of instructions, which when executed by one or more processors, cause the one or more processors to perform: invoking a tone generation element to generate a tone, the tone generation element comprising any one of: (i) an ID attribute; (ii) an iterate attribute; (iii) a barge attribute; (iv) a cleardb attribute; (v) an override attribute, or (vi) any combination of (i)-(v).

Clause 27. The non-transitory computer-readable medium of clause 26, wherein the tone generation element comprises: a tone child element, wherein the tone child element specifies the tone.

Clause 28. The non-transitory computer-readable medium of clause 27, wherein the tone child element comprises any one of (i) a tone1 child element including a first frequency and a first attenuation, (ii) a tone2 child element including a second frequency and a second attenuation, or (iii) a combination of (i) and (ii).

Clause 29. The non-transitory computer-readable medium of clause 28, having stored thereon the one or more sequences of instructions, which when executed by the one or more processors, cause the one or more processors to further perform: setting any one of (i) the first frequency, (ii) the first attenuation, (iii) the second frequency, (iv) the second attenuation, or (v) any combination of (i)-(iv) to set a frequency and an attenuation of the tone.

Clause 30. The non-transitory computer-readable medium of clause 27, wherein the tone child element comprises a silence child element, the silence child element comprising a silence duration attribute.

Clause 31. The non-transitory computer-readable medium of clause 30, having stored thereon the one or more sequences of instructions, which when executed by the one or more processors, cause the one or more processors to further perform: setting the silence duration attribute to set a tone off period.

Clause 32. The non-transitory computer-readable medium of clause 26, wherein the tone generation element comprises a silence child element, wherein the silence child element specifies a silence interval.

Clause 33. The non-transitory computer-readable medium of clause 32, wherein the silence child element comprises a periods per minutes attribute for synchronizing tones.

Clause 34. The non-transitory computer-readable medium of clause 33, having stored thereon the one or more sequences of instructions, which when executed by the one or more processors, cause the one or more processors to further perform: setting the periods per minute attribute to set one or more silence durations per minute; and generating synchronized tones at an end of a silence duration of the one or more silence durations per minute.

Clause 35. The non-transitory computer-readable medium of clause 34, wherein: the periods per minute attribute is set to four, setting the one or more silence durations per minute to fifteen seconds; and generating the synchronized tones at the end of the silence duration of the one or more silence durations per minute occurs at any one of (i) zero seconds, (ii) fifteen seconds, (iii) thirty seconds, or (iv) forty-five seconds of a minute.

Clause 36. The non-transitory computer-readable medium of clause 26, wherein: the iterate attribute is an integer variable specifying a total number of iterations; the barge attribute is a first Boolean variable that defines whether or not tones may be interrupted by DTMF; the cleardb attribute is a second Boolean variable that defines whether or not a digit buffer is cleared; and the override attribute is a third Boolean variable that defines whether or not the tone can be stopped in response to a command.

Clause 37. The non-transitory computer-readable medium of clause 36, having stored thereon the one or more sequences of instructions, which when executed by the one or more processors, cause the one or more processors to further perform: setting the iterate attribute to set the total number of iterations.

Clause 38. The non-transitory computer-readable medium of clause 36, having stored thereon the one or more sequences of instructions, which when executed by the one or more processors, cause the one or more processors to further perform: setting the barge attribute to enable interruption by DTMF.

Clause 39. The non-transitory computer-readable medium of clause 38, having stored thereon the one or more sequences of instructions, which when executed by the one or more processors, cause the one or more processors to further perform: receiving an incoming DTMF digit; and stopping the tone in response to receiving the incoming DTMF digit.

Clause 40. The non-transitory computer-readable medium of clause 36, having stored thereon the one or more sequences of instructions, which when executed by the one or more processors, cause the one or more processors to further perform: setting the override attribute to enable stopping the tone in response to the command.

Clause 41. The non-transitory computer-readable medium of clause 40, having stored thereon the one or more sequences of instructions, which when executed by the one or more processors, cause the one or more processors to further perform: invoking the command to stop the tone.

Clause 42. The non-transitory computer-readable medium of clause 41, wherein: the command is a stop tone sequence.

Clause 43. The non-transitory computer-readable medium of clause 36, wherein the tone is any one of (i) a continuous tone, (ii) a basic tone, (iii) a multiple pulse tone, or (iv) a sequential tone.

Clause 44. A method, comprising: invoking a tone generation element, wherein the tone generation element comprises a silence element that defines a periods per minute attribute for synchronizing tone generation of a plurality of client devices.

Clause 45. The method of clause 44, further comprising: executing the tone generation element to cause the plurality of client devices to generate one or more synchronized tones according to the periods per minute attribute.

Clause 46. The method of clause 45, wherein executing the tone generation element comprises: generating a waveform that represents a tone defined by the tone generation element; and instructing the plurality of client devices to generate the one or more synchronized tones at one or more times according to the periods per minute attribute.

Clause 47. The method of clause 46, wherein executing the tone generation element further comprises any one of (i) configuring audio processing components of the plurality of client devices, (ii) mixing the tone with an audio stream, or (iii) both (i) and (ii).

Clause 48. The method of clause 46, wherein the tone generation element comprises: a tone child element, wherein the tone child element specifies characteristics of the one or more synchronized tones.

Clause 49. The method of clause 44, wherein the tone generation element comprises any one of: (i) an ID attribute; (ii) an iterate attribute; (iii) a barge attribute; (iv) a cleardb attribute; (v) an override attribute, or (vi) any combination of (i)-(v).

Clause 50. The method of clause 44, wherein the periods per minute attribute is set to any one of: one, enabling the plurality of client devices to generate synchronized tones at the start of each minute; two, enabling the plurality of client devices to generate synchronized tones at the start of each minute and thirty seconds after the start of each minute; three, enabling the plurality of client devices to generate synchronized tones at the start of each minute and every twenty seconds after the start of each minute; four, enabling the plurality of client devices to generate synchronized tones at the start of each minute and every fifteen seconds after the start of each minute; five, enabling the plurality of client devices to generate synchronized tones at the start of each minute and every twelve seconds after the start of each minute; six, enabling the plurality of client devices to generate synchronized tones at the start of each minute and every ten seconds after the start of each minute; eight, enabling the plurality of client devices to generate synchronized tones at the start of each minute and every seven and one half seconds after the start of each minute; ten, enabling the plurality of client devices to generate synchronized tones at the start of each minute and every six seconds after the start of each minute; twelve, enabling the plurality of client devices to generate synchronized tones at the start of each minute and every five seconds after the start of each minute; fifteen, enabling the plurality of client devices to generate synchronized tones at the start of each minute and every four seconds after the start of each minute; sixteen, enabling the plurality of client devices to generate synchronized tones at the start of each minute and every three and three quarters seconds after the start of each minute; twenty, enabling the plurality of client devices to generate synchronized tones at the start of each minute and every three seconds after the start of each minute; twenty-four, enabling the plurality of client devices to generate synchronized tones at the start of each minute and every two and a half seconds after the start of each minute; twenty-five, enabling the plurality of client devices to generate synchronized tones at the start of each minute and every two and four tenths seconds after the start of each minute; thirty, enabling the plurality of client devices to generate synchronized tones at the start of each minute and every two seconds after the start of each minute; thirty-two, enabling the plurality of client devices to generate synchronized tones at the start of each minute and every one and seven eighths seconds after the start of each minute; forty, enabling the plurality of client devices to generate synchronized tones at the start of each minute and every one and a half seconds after the start of each minute; forty-eight, enabling the plurality of client devices to generate synchronized tones at the start of each minute and every one and one quarter seconds after the start of each minute; fifty, enabling the plurality of client devices to generate synchronized tones at the start of each minute and every one and two tenths seconds after the start of each minute; or sixty, enabling the plurality of client devices to generate synchronized tones at the start of each minute and every second after the start of each minute.

Clause 51. The method of clause 44, wherein the plurality of client devices are operable to utilize a networking protocol or reference time source to synchronize clocks.

Clause 52. The method of clause 51, wherein the networking protocol is Network Time Protocol.

Clause 53. A method, comprising: setting a periods per minute attribute of a silence element to set one or more silence durations per minute; invoking a tone generation element, wherein the tone generation element comprises the silence element; and executing the tone generation element to cause a plurality of client devices to generate one or more synchronized tones according to the periods per minute attribute.

Clause 54. The method of clause 53, wherein executing the tone generation element comprises: generating a waveform that represents a tone defined by the tone generation element; and instructing the plurality of client devices to generate the one or more synchronized tones at one or more times according to the periods per minute attribute.

Clause 55. The method of clause 54, wherein executing the tone generation element further comprises any one of (i) configuring audio processing components of the plurality of client devices, (ii) mixing the tone with an audio stream, or (iii) both (i) and (ii).

Clause 56. The method of clause 53, wherein the tone generation element comprises any one of: (i) an ID attribute; (ii) an iterate attribute; (iii) a barge attribute; (iv) a cleardb attribute; (v) an override attribute, or (vi) any combination of (i)-(v).

Clause 57. The method of clause 53, wherein the tone generation element comprises: a tone child element, wherein the tone child element specifies characteristics of the one or more synchronized tones.

Clause 58. The method of clause 53, wherein the periods per minute attribute is set to any one of: one, enabling the plurality of client devices to generate synchronized tones at the start of each minute; two, enabling the plurality of client devices to generate synchronized tones at the start of each minute and thirty seconds after the start of each minute;

three, enabling the plurality of client devices to generate synchronized tones at the start of each minute and every twenty seconds after the start of each minute; four, enabling the plurality of client devices to generate synchronized tones at the start of each minute and every fifteen seconds after the start of each minute; five, enabling the plurality of client devices to generate synchronized tones at the start of each minute and every twelve seconds after the start of each minute; six, enabling the plurality of client devices to generate synchronized tones at the start of each minute and every ten seconds after the start of each minute; eight, enabling the plurality of client devices to generate synchronized tones at the start of each minute and every seven and one half seconds after the start of each minute; ten, enabling the plurality of client devices to generate synchronized tones at the start of each minute and every six seconds after the start of each minute; twelve, enabling the plurality of client devices to generate synchronized tones at the start of each minute and every five seconds after the start of each minute; fifteen, enabling the plurality of client devices to generate synchronized tones at the start of each minute and every four seconds after the start of each minute; sixteen, enabling the plurality of client devices to generate synchronized tones at the start of each minute and every three and three quarters seconds after the start of each minute; twenty, enabling the plurality of client devices to generate synchronized tones at the start of each minute and every three seconds after the start of each minute; twenty-four, enabling the plurality of client devices to generate synchronized tones at the start of each minute and every two and a half seconds after the start of each minute; twenty-five, enabling the plurality of client devices to generate synchronized tones at the start of each minute and every two and four tenths seconds after the start of each minute; thirty, enabling the plurality of client devices to generate synchronized tones at the start of each minute and every two seconds after the start of each minute; thirty-two, enabling the plurality of client devices to generate synchronized tones at the start of each minute and every one and seven eighths seconds after the start of each minute; forty, enabling the plurality of client devices to generate synchronized tones at the start of each minute and every one and a half seconds after the start of each minute; forty-eight, enabling the plurality of client devices to generate synchronized tones at the start of each minute and every one and one quarter seconds after the start of each minute; fifty, enabling the plurality of client devices to generate synchronized tones at the start of each minute and every one and two tenths seconds after the start of each minute; or sixty, enabling the plurality of client devices to generate synchronized tones at the start of each minute and every second after the start of each minute.

Clause 59. The method of clause 53, wherein the plurality of client devices are operable to utilize a networking protocol or reference time source to synchronize clocks.

Clause 60. The method of clause 59, wherein the networking protocol is Network Time Protocol.

It should be understood that the FIGS. 1-8 are presented for illustrative purposes only. The architecture of the example embodiments presented herein is sufficiently flexible and configurable that it may be utilized and navigated in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method, comprising:
setting a periods per minute attribute of a silence element to set one or more silence durations per minute;
invoking a tone generation element, wherein the tone generation element comprises the silence element; and
executing the tone generation element to cause a plurality of client devices to generate one or more synchronized tones according to the periods per minute attribute.

2. The method of claim 1, wherein executing the tone generation element comprises:
generating a waveform that represents a tone defined by the tone generation element; and
instructing the plurality of client devices to generate the one or more synchronized tones at one or more times according to the periods per minute attribute.

3. The method of claim 2, wherein executing the tone generation element further comprises any one of (i) configuring audio processing components of the plurality of client devices, (ii) mixing the tone with an audio stream, or (iii) both (i) and (ii).

4. The method of claim 1, wherein the tone generation element comprises:
an ID attribute;
an iterate attribute;
a barge attribute;
a cleardb attribute; and
an override attribute.

5. The method of claim 4, wherein:
the iterate attribute is an integer variable specifying a total number of iterations;
the barge attribute is a first Boolean variable that defines whether tones may be interrupted by DTMF;
the cleardb attribute is a second Boolean variable that defines whether a digit buffer is cleared; and
the override attribute is a third Boolean variable that defines whether tones can be stopped in response to a command.

6. The method of claim 1, further comprising:
setting an iterate attribute of the tone generation element to a total number of iterations.

7. The method of claim 1, further comprising:
setting a barge attribute of the tone generation element to enable interruption by DTMF;
receiving an incoming DTMF digit; and
stopping a tone in response to receiving the incoming DTMF digit.

8. The method of claim 1, further comprising:
setting an override attribute to enable stopping tones in response to a command; and
invoking the command to stop a tone.

9. The method of claim 1, wherein the tone generation element comprises:
a tone child element, wherein the tone child element specifies one or more characteristics of the one or more synchronized tones.

10. The method of claim 1, wherein the periods per minute attribute is set to any one of:
one, enabling the plurality of client devices to generate synchronized tones at the start of each minute;
two, enabling the plurality of client devices to generate synchronized tones at the start of each minute and thirty seconds after the start of each minute;
three, enabling the plurality of client devices to generate synchronized tones at the start of each minute and every twenty seconds after the start of each minute;
four, enabling the plurality of client devices to generate synchronized tones at the start of each minute and every fifteen seconds after the start of each minute;
five, enabling the plurality of client devices to generate synchronized tones at the start of each minute and every twelve seconds after the start of each minute;
six, enabling the plurality of client devices to generate synchronized tones at the start of each minute and every ten seconds after the start of each minute;
eight, enabling the plurality of client devices to generate synchronized tones at the start of each minute and every seven and one half seconds after the start of each minute;
ten, enabling the plurality of client devices to generate synchronized tones at the start of each minute and every six seconds after the start of each minute;
twelve, enabling the plurality of client devices to generate synchronized tones at the start of each minute and every five seconds after the start of each minute;
fifteen, enabling the plurality of client devices to generate synchronized tones at the start of each minute and every four seconds after the start of each minute;
sixteen, enabling the plurality of client devices to generate synchronized tones at the start of each minute and every three and three quarters seconds after the start of each minute;
twenty, enabling the plurality of client devices to generate synchronized tones at the start of each minute and every three seconds after the start of each minute;
twenty-four, enabling the plurality of client devices to generate synchronized tones at the start of each minute and every two and one half seconds after the start of each minute;
twenty-five, enabling the plurality of client devices to generate synchronized tones at the start of each minute and every two and four tenths seconds after the start of each minute;
thirty, enabling the plurality of client devices to generate synchronized tones at the start of each minute and every two seconds after the start of each minute;
thirty-two, enabling the plurality of client devices to generate synchronized tones at the start of each minute and every one and seven eighths seconds after the start of each minute;
forty, enabling the plurality of client devices to generate synchronized tones at the start of each minute and every one and one half seconds after the start of each minute;
forty-eight, enabling the plurality of client devices to generate synchronized tones at the start of each minute and every one and one quarter seconds after the start of each minute;
fifty, enabling the plurality of client devices to generate synchronized tones at the start of each minute and every one and two tenths seconds after the start of each minute; or
sixty, enabling the plurality of client devices to generate synchronized tones at the start of each minute and every second after the start of each minute.

11. The method of claim 1, wherein the plurality of client devices are operable to utilize a networking protocol or reference time source to synchronize clocks.

12. The method of claim 11, wherein the networking protocol is Network Time Protocol.

13. A non-transitory computer-readable medium having stored thereon one or more sequences of instructions, which when executed by one or more processors, cause the one or more processors to perform:
setting a periods per minute attribute of a silence element to set one or more silence durations per minute;
invoking a tone generation element, wherein the tone generation element comprises the silence element; and
executing the tone generation element to cause a plurality of client devices to generate one or more synchronized tones according to the periods per minute attribute.

14. The non-transitory computer-readable medium of claim 13, the non-transitory computer-readable medium having stored thereon the one or more sequences of instructions, which when executed by the one or more processors, cause the one or more processors to further perform:
generating a waveform that represents a tone defined by the tone generation element; and
instructing the plurality of client devices to generate the one or more synchronized tones at one or more times according to the periods per minute attribute.

15. The non-transitory computer-readable medium of claim 13, wherein the tone generation element comprises any one of: (i) an ID attribute; (ii) an iterate attribute; (iii) a barge attribute; (iv) a cleardb attribute; (v) an override attribute, or (vi) any combination of (i)-(v).

16. The non-transitory computer-readable medium of claim 15, wherein:
the iterate attribute is an integer variable specifying a total number of iterations;
the barge attribute is a first Boolean variable that defines whether tones may be interrupted by DTMF;
the cleardb attribute is a second Boolean variable that defines whether a digit buffer is cleared; and
the override attribute is a third Boolean variable that defines whether tones can be stopped in response to a command.

17. A system, comprising:
one or more processors; and
a computer-readable storage medium coupled to the one or more processors and comprising instructions thereon that, when executed by the one or more processors, cause the one or more processors to:
set a periods per minute attribute of a silence element to set one or more silence durations per minute;
invoke a tone generation element, wherein the tone generation element comprises the silence element; and
execute the tone generation element to cause a plurality of client devices to generate one or more synchronized tones according to the periods per minute attribute.

18. The system of claim 17, the computer-readable storage medium comprising further instruction thereon that, when executed by the one or more processors, cause the one or more processors to:
generate a waveform that represents a tone defined by the tone generation element; and
instruct the plurality of client devices to generate the one or more synchronized tones at one or more times according to the periods per minute attribute.

19. The system of claim 17, wherein the tone generation element comprises any one of: (i) an ID attribute; (ii) an iterate attribute; (iii) a barge attribute; (iv) a cleardb attribute; (v) an override attribute, or (vi) any combination of (i)-(v).

20. The system of claim 17, wherein the plurality of client devices are operable to utilize a networking protocol or reference time source to synchronize clocks.
